(19) United States
(12) Patent Application Publication
(10) Pub. No.: US 2026/0319259 A1
(43) Pub. Date: Oct. 15, 2026

(54) OPTICAL WAVEGUIDE STRUCTURE AND DISPLAY DEVICE

(71) Applicants: Interface Advanced Technology (Chengdu) Co., Ltd., Chengdu (CN); Interface Technology (ChengDu) Co., Ltd., Chengdu (CN); INTERFACE OPTOELECTRONICS (SHENZHEN) CO., LTD., Shenzhen (CN); GENERAL INTERFACE SOLUTION LIMITED, Zhunan (TW)

(72) Inventors: Po-Lun Chen, Zhunan (TW); Yun-Pei Chen, Zhunan (TW); Jin-Mao Zhuang, Zhunan (TW); Ting-Hui Chen, New Taipei (TW)

(21) Appl. No.: 19/674,327

(22) Filed: May 12, 2026

Related U.S. Application Data
(63) Continuation-in-part of application No. PCT/CN2025/073239, filed on Jan. 20, 2025.

(51) Int. Cl. G02B 27/01; G02B 6/34

(52) U.S. Cl. CPC G02B 27/0172; G02B 6/34

(57) ABSTRACT

An optical waveguide structure and a display device are provided. The optical waveguide structure includes a first light-guiding part, and a second light-guiding part spliced together. A refractive index of the first light-guiding part is less than that of the second light guide part. An input grating and an output grating are both on the first light-guiding. Image light is coupled into the optical waveguide through the input grating, propagates through the first light-guiding part, the second light-guiding part and back to the first light-guiding part, and is then coupled out of the optical waveguide from the output grating.

### FIELD

The subject matter herein generally relates to an optical waveguide structure and a display device including the optical waveguide structure.

### BACKGROUND

Display devices utilizing Augmented Reality (AR) technology (abbreviated as AR display devices), which integrate virtual images into real-world scenes to enable users to naturally interact with digital content, have become an industry development goal. AR display devices include AR near-eye display devices and AR heads-up display devices. Optical waveguides are increasingly regarded as a mainstream solution for meeting imaging requirements of AR display devices. This is primarily because optical waveguides can achieve total internal reflection of light: after an optical engine completes imaging (generating image light), the image light is coupled into the optical waveguide, which transmits the image light to human eyes (for near-eye display devices) or the front of a windshield (for heads-up display devices) through the principle of “total internal reflection”, and then releases the image light, which is received and imaged by human eyes.

Currently, in AR display devices, during the image light transmitting from an input grating to an output grating in the optical waveguide, some of the image light gradually shifts towards edges of the optical waveguide, which makes it difficult for this portion of the image light to exit from an area of the output grating corresponding to eye box, leading to a reduction in an amount of image light received by the human eyes and a perceived dimming of the displayed image for the user.

Therefore, there is room for improvement in the art.

### BRIEF DESCRIPTION OF THE DRAWINGS

Implementations of the present disclosure will now be described, by way of embodiment, with reference to the attached figures.

FIG. 1 is a planar view of an optical waveguide structure according to related art.

FIG. 2 is a structural diagram of an optical waveguide structure according to a first embodiment of the present disclosure.

FIG. 3 is a planar view of the optical waveguide structure shown in FIG. 2.

FIG. 4 is a planar view of an optical waveguide structure according to another embodiment of the present disclosure, in which an input grating and an output grating are on different surfaces of the optical waveguide.

FIG. 5 illustrated optical paths in the optical waveguide structure shown in FIG. 2.

FIG. 6 is a planar view of an optical waveguide structure according to a second embodiment of the present disclosure.

FIG. 7 illustrated optical paths in the optical waveguide structure shown in FIG. 6.

FIG. 8 is a planar view of an optical waveguide structure according to a third embodiment of the present disclosure.

FIG. 9 is a planar view of an optical waveguide structure according to a fourth embodiment of the present disclosure.

FIG. 10 is a structural diagram of an AR near-eye display device according to an embodiment of the present disclosure.

FIG. 11 illustrated optical paths in the AR near-eye display device shown in FIG. 10.

FIG. 12 illustrated optical paths in an AR head-up display device according to an embodiment of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein may be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

The term “comprising” when utilized, means “including, but not necessarily limited to”; it specifically indicates open-ended inclusion or membership in the so-described combination, group, series, and the like. The disclosure is illustrated by way of example and not by way of limitation in the figures of the accompanying drawings in which like references indicate similar elements. It should be noted that references to “an” or “one” embodiment in this disclosure are not necessarily to the same embodiment, and such references can mean “at least one”. The term “circuit” is defined as an integrated circuit (IC) with a plurality of electric elements, such as capacitors, resistors, amplifiers, and the like.

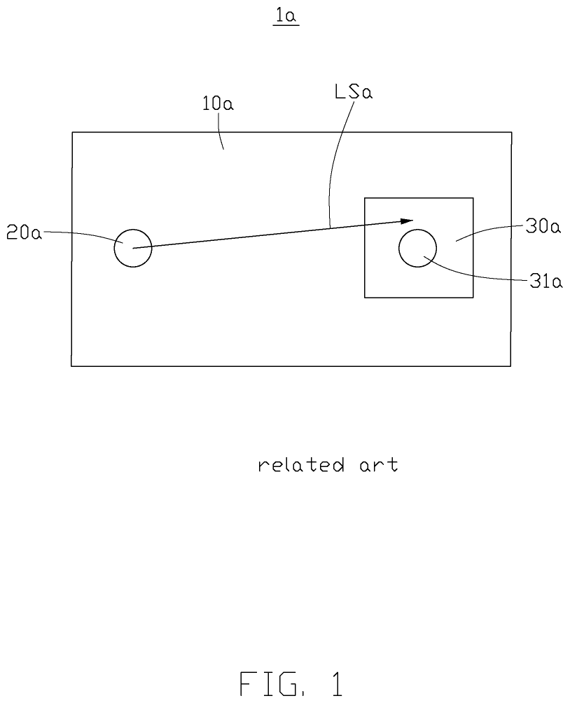

FIG. 1 is a planar view of an optical waveguide structure 1a in related art. As shown in FIG. 1, the optical waveguide structure 1a includes an optical waveguide 10a, an input grating 20a, and an output grating 30a. The input grating 20a and the output grating 30a are spaced apart from each other and on a same surface of the optical waveguide 10a. The input grating 20a is configured to couple an image light LSa into the optical waveguide 10a, so that the image light LSa propagates within the optical waveguide 10a in a direction toward the output grating 30a. The output grating 30a is configured to couple the image light LSa out of the optical waveguide 10a.

When the optical waveguide structure 1a of the related art is applied to an AR display device, at least the following problems exist. Specifically, when a user uses the AR display device, the amount of image light coupled out from the output grating 30a that can be received by the human eyes is limited. That is, only a portion of all the image light LSa coupled out from the output grating 30a can be received by the human eyes. The exit area on the output grating 30a corresponding to the image light LSa that can be received by the human eyes is defined as a receiving zone 31a. During the propagation of the image light LSa from the input grating 20a to the output grating 30a, a portion of the image light LSa deviates from a preset propagation direction and shifts toward edges of the optical waveguide 10a, making it difficult for that portion of image light LSa to be coupled out of the optical waveguide 10a from the receiving zone 31a and ultimately be received by the human eyes, and resulting in a decrease in a brightness of the displayed image seen by the human eyes.

The technical solutions in the embodiments of the present disclosure will be clearly and completely described below with reference to the accompanying drawings. Obviously, the described embodiments are a part of the embodiments of the present disclosure, rather than all the embodiments.

It should be noted that when a component is referred to as being “fixed to” or “mounted on” another component, it can be directly on the other component or intervening components may also be present. When a component is considered to be “on” another component, it can be directly disposed on the other component or intervening components may potentially be present. The term “and/or” as used herein includes any and all combinations of one or more of the associated listed items. The terms used in the specification of the present disclosure are for the purpose of describing specific embodiments and are not intended to limit the present disclosure.

To further elaborate on the technical means and effects adopted by the present disclosure to achieve the predetermined purpose, the following detailed description is made with reference to the accompanying drawings and embodiments.

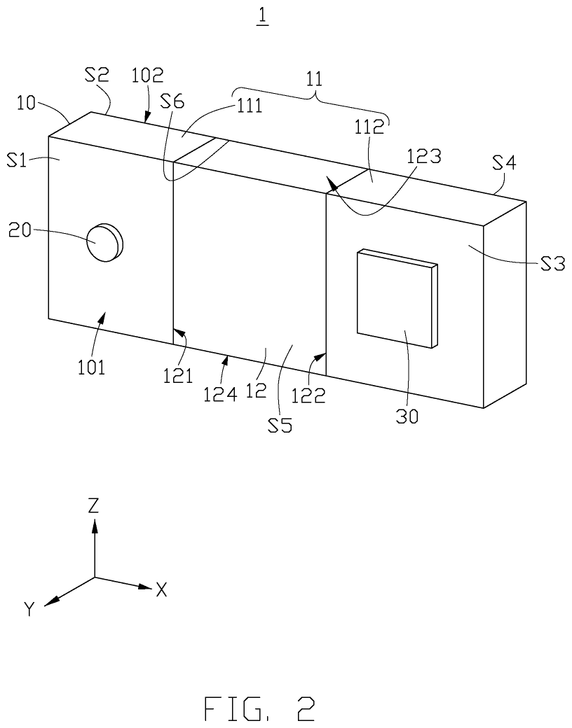

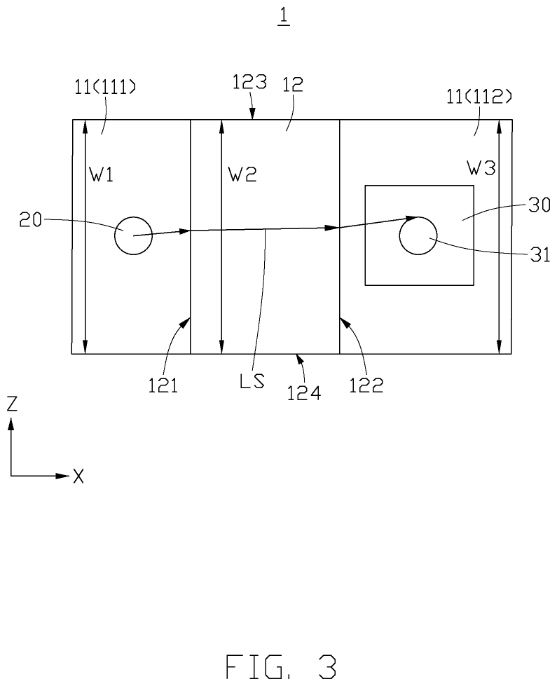

As shown in FIGS. 2 and 3, the optical waveguide structure 1 of a first embodiment of the present disclosure includes an optical waveguide 10 and an input grating 20 and an output grating 30. The input grating 20 and the output grating 30 are spaced apart from each other in a first direction X and on a same surface of the optical waveguide 10. The input grating 20 is configured to couple an image light LS into the optical waveguide 10, and the output grating 30 is configured to couple the image light LS from the input grating 20 out of the optical waveguide 10, so that the image light LS is received by the human eyes, thereby allowing the user to see a display image formed by the image light LS.

The optical waveguide 10 includes a first light-guiding part 11 and a second light-guiding part 12 adjacent to the first light-guiding part 11. A refractive index of the first light-guiding part 11 is less than a refractive index of the second light-guiding part 12, and the refractive index of the second light-guiding part 12 ranges from 1.3 to 2.5 (including endpoints). In some embodiments, the second light-guiding part 12 is spliced with the first light-guiding part 11.

An orthographic projection of the input grating 20 on the optical waveguide 10 along a thickness direction of the optical waveguide 10 is on the first light-guiding part 11. An orthographic projection of the output grating 30 on the optical waveguide 10 along the thickness direction of the optical waveguide 10 is on the first light-guiding part 11. The thickness direction of the optical waveguide 10 is defined as a second direction Y, which is perpendicular to the first direction X.

Each of the input grating 20 and the output grating 30 is on a surface of the first light-guiding part 11. The second light-guiding part 12 is positioned in an optical path between the input grating 20 and the output grating 30 and configured to expand the image light LS. After the image light LS is coupled into the optical waveguide 10 from the input grating 20, it sequentially passes through the first light-guiding part 11, the second light-guiding part 12, and the first light-guiding part 11, and is then coupled out of the optical waveguide 10 from the output grating 30.

The optical waveguide 10 as a whole is substantially a rectangular thin plate-like structure, including a first surface 101 and a second surface 102 that are spaced apart and face away from each other. The input grating 20 and the output grating 30 are spaced apart from each other and on the first surface 101. The input grating 20 has a substantially circular thin plate-like structure, and the output grating 30 has a substantially rectangular thin plate-like structure. A line connecting geometric centers of the input grating 20 and the output grating 30 is parallel to long sides of the first surface 101 and is equidistant from two long sides of the first surface 101.

In other embodiments, the input grating 20 and the output grating 30 may have other geometric structures, such as rhombic or hexagonal.

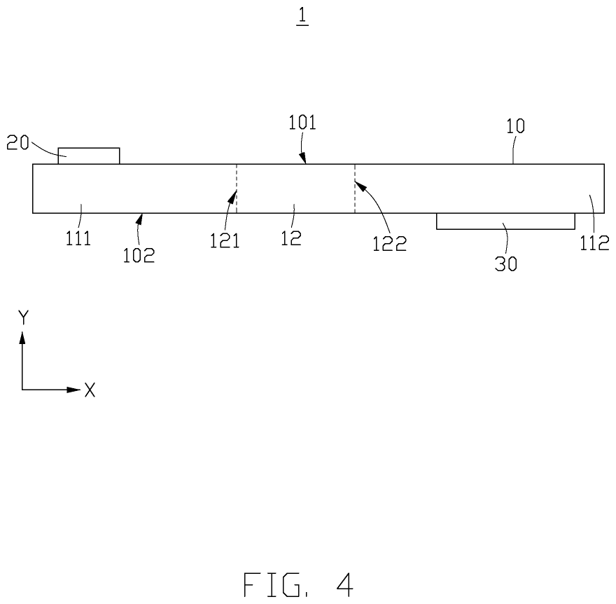

In other embodiments, as shown in FIG. 4, the input grating 20 and the output grating 30 are on opposite surfaces of the optical waveguide 10, respectively. The input grating 20 is on the first surface 101 and the output grating 30 is on the second surface 102.

The first light-guiding part 11 includes a first portion 111 and a second portion 112 separated from each other in the first direction X. The first portion 111 and the second portion 112 are respectively connected to two opposite ends of the second light-guiding part 12 and are flush with the second light-guiding part 12 in the thickness direction.

The first portion 111, the second light-guiding part 12, and the second portion 112 are all rectangular thin plate-like structures, and are spliced in sequence to form the optical waveguide 10. A thicknesses of the first portion 111, a thicknesses of the second portion 112, and a thicknesses of the second light-guiding part 12 are the same. The first light-guiding part 11 and the second light-guiding part 12 are substantially coplanar.

Referring to FIG. 2, the first light-guiding part 11 and the second light-guiding part 12 each have two opposing surfaces in the thickness direction of the optical waveguide 10, and the two opposing surfaces of the first light-guiding part 11 are substantially and respectively coplanar with the two opposing surfaces of the second light-guiding part 12.

The first portion 111 has two opposing surfaces (i.e. a first sub surface S1 and a first sub surface S2) in the thickness direction of the optical waveguide 10, the second portion 112 has two opposing surfaces (i.e. a third sub surface S3 and a fourth sub surface S4) in the thickness direction of the optical waveguide 10, and the second light-guiding part 12 has two opposing surfaces (i.e. a fifth sub surface S5 and a sixth sub surface S6) in the thickness direction of the optical waveguide 10. The input grating 20 is on the first sub surface S1, and the output grating 30 is on the third sub surface S3. The first sub surface S1, the third sub surface S3, and the fifth sub surface S5 are substantially coplanar. The second sub surface S2, the fourth sub surface S4, and the sixth sub surface S6 are substantially coplanar.

In some embodiments, the first surface 101 is composed of a surface of the first light-guiding part 11 and a surface of the second light-guiding part 12, and the second surface 102 is composed of a surface of the first light-guiding part 11 and a surface of the second light-guiding part 12. That is, the first surface 101 is composed of the first sub surface S1, the third sub surface S3, and the fifth sub surface S5. The second surface 102 is composed of the second sub surface S2, the fourth sub surface S4, and the sixth sub surface S6.

In a third direction Z, a width W1 of the first portion 111, a width W2 of the second portion 112, and a width W3 of the second light-guiding part 12 are the same. The third direction Z, the second direction Y and the first direction X are perpendicular to each other.

The input grating 20 is on a surface of the first portion 111, the output grating 30 is on a surface of the second portion 112, and the second light-guiding part 12 is between and interfaces with the first portion 111 and the second portion 112, so that after the image light LS is coupled into the first portion 111 from the input grating 20, the image light LS sequentially propagates through the first portion 111, the second light-guiding part 12, and the second portion 112, and coupled out of the second portion 112 from the output grating 30.

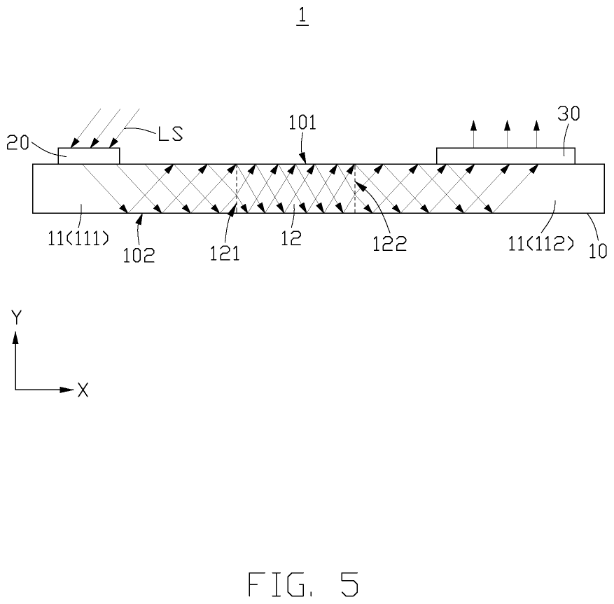

As shown in FIG. 5, the first light-guiding part 11 and the second light-guiding part 12 are flush in the thickness direction of the optical waveguide 10. Each of the first surface 101 and the second surface 102 is jointly formed by the first light-guiding part 11 and the second light-guiding part 12, and the first surface 101 and the second surface 102 are each substantially smooth planes. A thickness of the first light-guiding part 11 is equal to a thickness of the second light-guiding part 12, so that the image light LS can propagate forward after being alternately reflected by the first surface 101 and the second surface 102 within the first light-guiding part 11 and the second light-guiding part 12, respectively.

The second light-guiding part 12 further includes a first side surface 121 connected to the first light-guiding part 11 and a second side surface 122 connected to the first light-guiding part 11. The first side surface 121 and the second side surface 122 are between the first surface 101 and the second surface 102, and are respectively connected to the first surface 101 and the second surface 102. In some embodiments, each the first side surface 121 and the second side surface 122 is a planar surface. The first side surface 121 and the second side surface 122 are substantially parallel to each other and are both substantially perpendicular to the first surface 101. The first side surface 121 and the second side surface 122 are spaced apart from each other in the direction from the input grating 20 to the output grating 30. In the first direction X, the first side surface 121 is closer to the input grating 20 than to the output grating 30. The first side surface 121 is connected to the first portion 111, and the second side surface 122 is connected to the second portion 112.

In some embodiments, the first light-guiding part 11 includes a transparent solid material, and the transparent solid material can be, but not limited to, glass, plastic, or a combination of both. In some embodiments, the second light-guiding part 12 includes a material selected from the group consisting of a transparent solid and a transparent liquid, the transparent solid material can be, but not limited to, glass, plastic, or a combination of both, and the transparent liquid can be, but not limited to, water or oil.

In some embodiments, each of the first light-guiding part 11 and the second light-guiding part 12 is a transparent solid structure. The material of the second light-guiding part 12 can be, but not limited to, glass, plastic, or a combination of both.

In other embodiments, the first light-guiding part 11 is a transparent solid structure, and the second light-guiding part 12 is a transparent liquid structure, where the material of the second light-guiding part 12 includes water or oil. In this case, the second light-guiding part 12 is within a solid container, and a refractive index of the solid container is the same as the refractive index of the first light-guiding part 11.

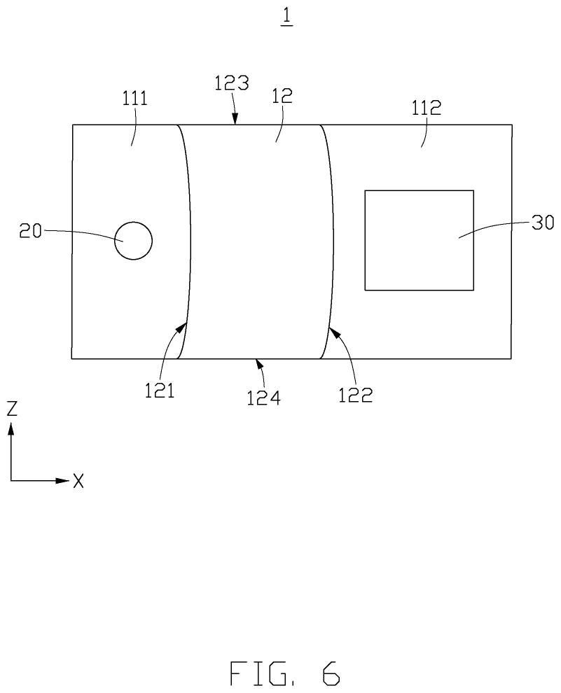

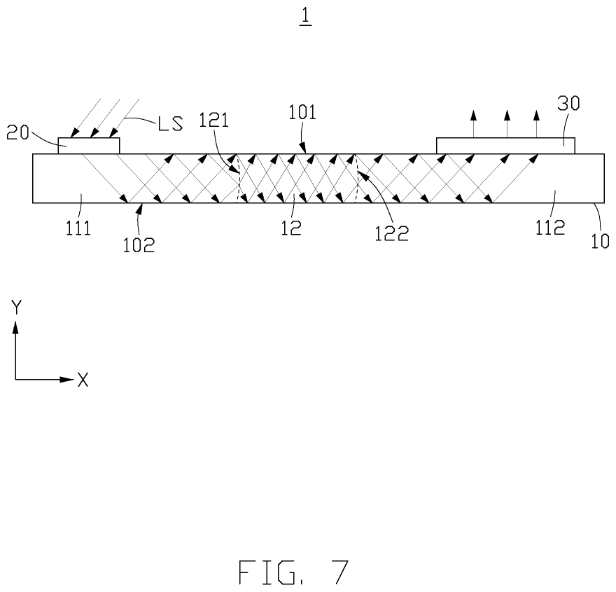

As shown in FIGS. 6 and 7, in an optical waveguide structure 1 of a second embodiment, each of the first side surface 121 and the second side surface 122 is a curved surface having one curvature. In some embodiments, each of the first side surface 121 and the second side surface 122 is a spherical curved surface, and a curvature of the second side surface 122 is less than or equal to a curvature of the first side surface 121. The first side surface 121 and the second side surface 122 are curved toward the output grating 30. Since each of the two opposite side surfaces (the first side surface 121 and the second side surface 122) of the second light-guiding part 12 is the spherical curved surface, and the second light-guiding part 12 is made of a transparent material, a lens is an optical element made of transparent substances (such as glass, crystal, etc.) with two refractive curved surfaces. Therefore, the second light-guiding part 12 can be regarded as a lens structure, the first side surface 121 is an object-side surface of the second light-guiding part 12, and the second side surface 122 is an image-side surface of the second light-guiding part 12. A process of transmitting the image light LS from the first portion 111 through the second light-guiding part 12 to the second portion 112 is equivalent to an imaging process of the second light-guiding part 12.

Since the image light LS is a parallel beam, an object distance in the imaging process of the second light-guiding part 12 is infinite. To ensure that the image light LS after transmission through the second light-guiding part 12 is also a parallel beam, that is, to make an image distance in the imaging process of the second light-guiding part 12 infinite, according to the lens imaging formula, a focal length of the second light-guiding part 12 should be designed to be infinite. From the lens maker's equation, it can be derived that a radius of curvature of the first side surface 121 and a radius of curvature of the second side surface 122 should satisfy a following relationship:

n2×(R2−R1+d)−d×n1=0;
wherein n1 is the refractive index of the first light-guiding part 11, n2 is the refractive index of the second light-guiding part 12, R1 is the radius of curvature of the first side surface 121, R2 is the radius of curvature of the second side surface 122, and d is a shortest distance between the first side surface 121 and the second side surface 122 (where each of R1 and R2 is not infinite), which can also be said to be the distance between the first side surface 121 and the second side surface 122 along a line connecting a spherical center of the first side surface 121 and a spherical center of the second side surface 122.

Since the first side surface 121 of the second light-guiding part 12 and the second side surface 122 of the second light-guiding part 12 are smooth spherical surfaces protruding in a same direction, and the curvature of the second side surface 122 is less than or equal to the curvature of the first side surface 121, the second light-guiding part 12 acts as a concave lens structure when the curvature of the second side surface 122 is less than that of the first side surface 121. A concave lens structure generally diverges a parallel beam. Therefore, after the image light LS is transmitted through the second light-guiding part 12, a beam radius of the image light LS expands, which causes the beam radius of the image light LS exiting from the output grating 30 to expand accordingly, thereby achieving an exit pupil expansion effect.

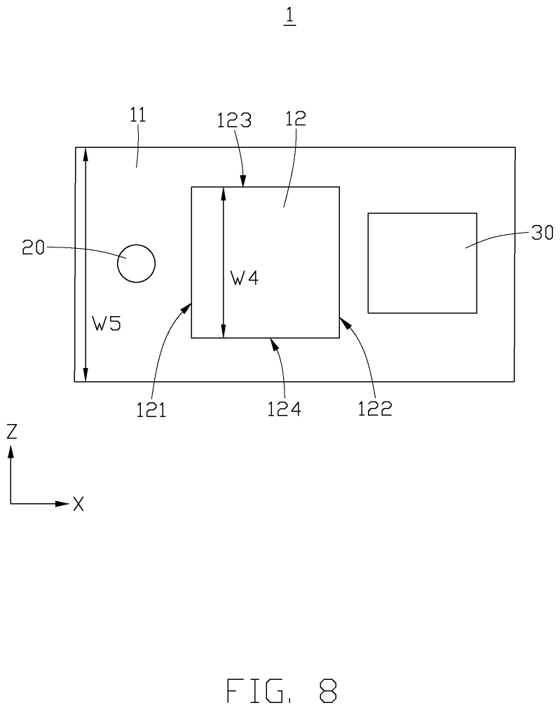

As shown in FIG. 8, in an optical waveguide structure 1 of a third embodiment, the first light-guiding part 11 surrounds the second light-guiding part 12. In some embodiments, the first light-guiding part 11 is not separated by the second light-guiding part 12, the first light-guiding part 11 has a substantially rectangular opening, and the second light-guiding part 12 is a thin plate-like structure with a substantially rectangular outline. The first light-guiding part 11 surrounds and connects to an outer edge of the second light-guiding part 12. Along the third direction Z, the width W4 of the second light-guiding part 12 is less than a width W5 of the outer outline of the first light-guiding part 11. In one embodiment, the first side surface 121 and the second side surface 122 are substantially parallel planar surfaces, and both perpendicular to the first surface 101.

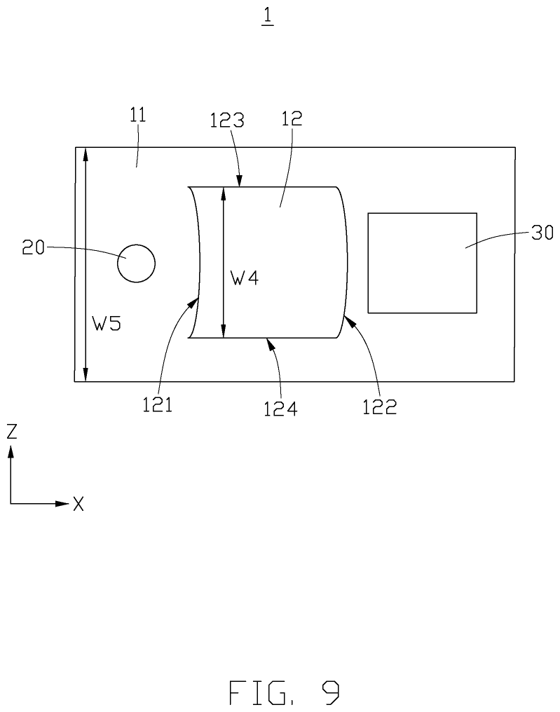

As shown in FIG. 9, in an optical waveguide structure 1 of a fourth embodiment, each of the first side surface 121 and the second side surface 122 is a curved surface, and the radii of curvature of the first side surface 121 and the second side surface 122 satisfy the relationship in the second embodiment, so that the beam radius of the image light LS after transmission through the second light-guiding part 12 expands, thereby achieving the pupil expansion effect.

As shown in FIGS. 3, 6, 8, and 9, in the first through fourth embodiments, the second light-guiding part 12 further includes a third side surface 123 and a fourth side surface 124 spaced apart and opposite to each other. Each of the third side surface 123 and the fourth side surface 124 is between the first surface 101 and the second surface 102, and further between the first side surface 121 and the second side surface 122. The first side surface 121, the third side surface 123, the second side surface 122, and the fourth side surface 124 are connected in sequence to form side walls of the second light-guiding part 12. In the first through fourth embodiments, each of the third side surface 123 and the fourth side surface 124 is, but not limited to, a planar surface. In other embodiments, each of the third side surface 123 and the fourth side surface 124 can be a curved surface.

As shown in FIGS. 8 and 9, each of the third side surface 123 and the fourth side surface 124 is connected to first the light-guiding part 11. The with W4 is a distance between the third side surface 123 and the fourth side surface 124 in the third direction Z.

As shown in FIG. 3, in order to allow more image light to exit from the area (receiving zone 31) on the output grating 30 that can be received by the human eyes and to improve the brightness of the display image seen by the human eyes when using the display device, the optical waveguide 10 of the optical waveguide structure 1 includes the first light-guiding part 11 and the second light-guiding part 12, where the refractive index of the first light-guiding part 11 is less than that of the second light-guiding part 12. The second light-guiding part 12 is configured to refract and transmit the image light LS, causing the image light LS to shift away from the edges of the optical waveguide 10, thereby reducing a degree of shift of the image light LS toward the edges of the optical waveguide 10, increasing the amount of image light LS exiting from the receiving zone 31, enabling the human eyes to see more image light LS and thus improving the brightness of the displayed image.

The optical waveguide structure of the embodiments of the present disclosure can be applied to display devices using AR technology, such as AR near-eye display devices and AR head-up display devices.

An embodiment of the present disclosure further provides a display device applying the above optical waveguide structure. The display device includes a display for emitting an image light; and the optical waveguide structure described in any of the above embodiments. The input grating is on an optical path of the image light for coupling the image light into the optical waveguide.

The following descriptions take the AR near-eye display device and the AR head-up display device applying the above optical waveguide structure as examples.

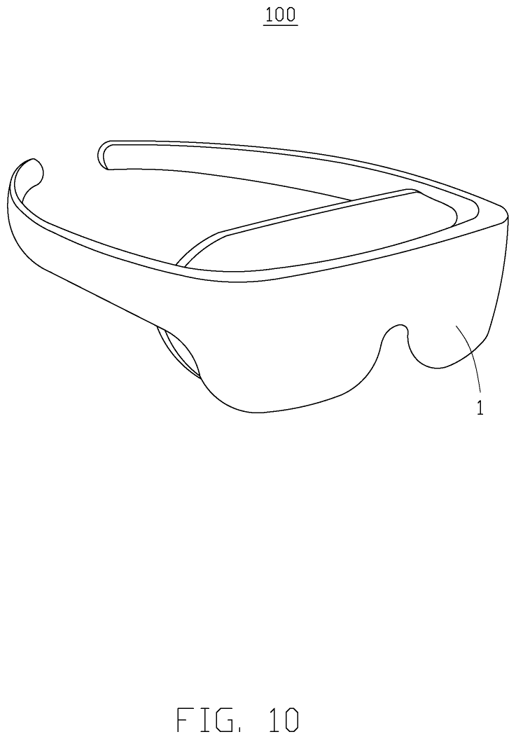

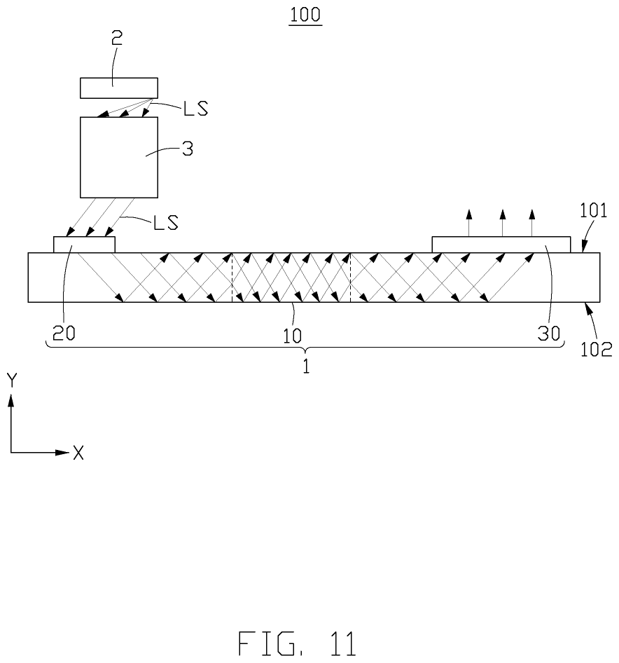

FIGS. 10 and 11 show an AR near-eye display device 100 applying the optical waveguide structure 1 according to an embodiment of the present disclosure.

The AR near-eye display device 100 includes an optical waveguide structure 1, a display 2, and a collimating lens 3. The display 2 is configured to emit the image light LS. The optical waveguide structure 1 is on the optical path of the image light LS, and the input grating 20 and the output grating 30 are on the first surface 101. The display 2 can be, but is not limited to, a liquid crystal display (LCD), a micro-light-emitting diode (Micro-LED) display, a digital light processing (DLP) display, a laser beam scanning (LBS) display, or an active-matrix organic light-emitting diode (AMOLED) display. The LCD may include be a fast response LCD, or a liquid crystal display on silicon (LCoS). The AMOLED display may be an OLED display on silicon.

The collimating lens 3 is between the display 2 and the input grating 20 and is spaced apart from the display 2 and the optical waveguide 10. The image light LS emitted by the display 2 is a non-parallel beam, and the collimating lens 3 is configured to convert the image light LS from the display 2 into a parallel beam before the image light LS exits to the input grating 20. That is, the input grating 20 is on an optical path of the parallel image light LS exiting from the collimating lens 3. Parallel light has a uniform light intensity distribution and a small divergence angle, which allows the parallel light to be more uniformly distributed on the surface of the optical waveguide 10 before entering the optical waveguide 10. Converting the image light LS into a parallel beam helps reduce scattering when the image light LS is coupled into the optical waveguide 10 through the input grating 20, thereby improving light coupling efficiency. A polarization state of the image light LS can be circular polarization or linear polarization. A wavelength range of the image light LS is generally 400 nm to 700 nm (including endpoints). A color of the image light LS can be formed by mixing red, green, and blue in different proportions. The present disclosure does not limit the polarization state, color, or wavelength of the image light LS.

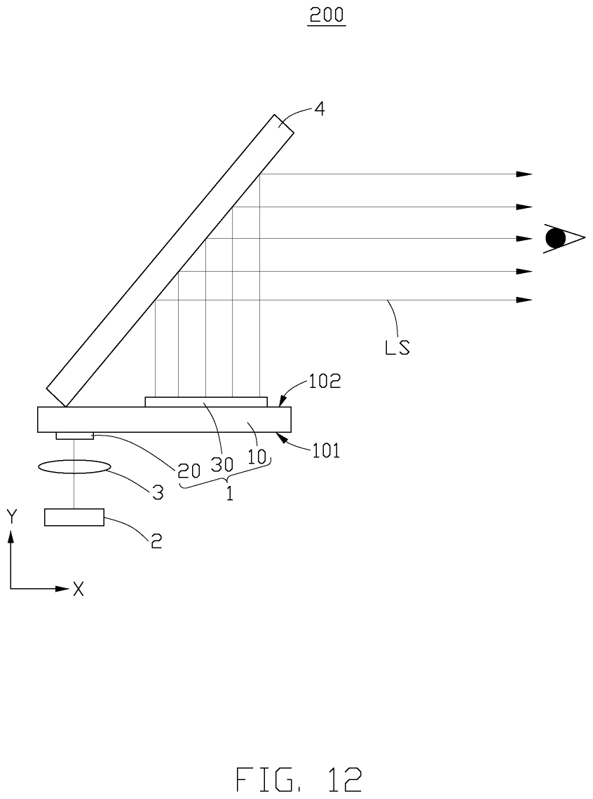

FIG. 12 shows an AR head-up display (HUD) device 200 applying the optical waveguide structure 1 according to an embodiment of the present disclosure.

The AR head-up display device 200 includes the optical waveguide structure 1, the display 2, the collimating lens 3, and an imaging medium 4. In the AR head-up display device 200, the input grating 20 and the output grating 30 are on different surfaces of the optical waveguide 10. The input grating 20 is on the first surface 101 and the output grating 30 is on the second surface 102. The imaging medium 4 is on the optical path of the image light LS exiting from the output grating 30 and is configured to reflect the image light LS to the human eyes, allowing the user to see the display image from the display 2. The imaging medium 4 is further configured to transmit ambient light, enabling the user to see a combination of the display image of the display 2 and an external scene, thereby achieving augmented reality. The imaging medium 4 can be a flat mirror, a concave mirror, or a combination of multiple mirrors with different shapes. The present disclosure does not limit the shape and number of the imaging medium 4.

It is to be understood, even though information and advantages of the present exemplary embodiments have been set forth in the foregoing description, together with details of the structures and functions of the present exemplary embodiments, the disclosure is illustrative only. Changes may be made in detail, especially in matters of shape, size, and arrangement of parts within the principles of the present exemplary embodiments to the full extent indicated by the plain meaning of the terms in which the appended claims are expressed.

What is claimed is:

1. An optical waveguide structure, comprising:
an optical waveguide comprising a first light-guiding part having a first refractive index and a second light-guiding part spliced with the first light guide portion and having a second refractive index greater than the first refractive index;
an input grating on the first light-guiding part and configured to couple image light into the optical waveguide; and
an output grating on the first light-guiding part and configured to couple the image light out of the optical waveguide;
wherein the second light-guiding part is positioned in an optical path between the input grating and the output grating and configured to expand the image light.

2. The optical waveguide structure according to claim 1, wherein the first light-guiding part comprises a first portion and a second portion separated from each other, the input grating is on the first portion, the output grating is on the second portion, and the second light-guiding part is between and interfaces with the first portion and the second portion.

3. The optical waveguide structure according to claim 1, wherein the first light-guiding part surrounds the second light-guiding part.

4. The optical waveguide structure according to claim 1, wherein the first light-guiding part and the second light-guiding part each have two opposing surfaces in a thickness direction of the optical waveguide, and the two opposing surfaces of the first light-guiding part are substantially and respectively coplanar with the two opposing surfaces of the second light-guiding part.

5. The optical waveguide structure according to claim 4, wherein the second light-guiding part further comprises a first side surface connected to the first light-guiding part and a second side surface connected to the first light-guiding part, the first side surface is closer to the input grating than to the second side surface; and the first side surface and the second side surface are substantially planar surfaces parallel to each other.

6. The optical waveguide structure according to claim 4, wherein the second light-guiding part further comprises a first side surface connected to the first light-guiding part and a second side surface connected to the first light-guiding part, the first side surface is closer to the input grating than to the second side surface; and each of the first side surface and the second side surface is a curved surface having one curvature convex toward the output grating.

7. The optical waveguide structure according to claim 6, wherein each of the first side surface and the second side surface is a spherical curved surface convex toward the output grating, and a curvature of the second side surface is less than or equal to a curvature of the first side surface.

8. The optical waveguide structure according to claim 7, satisfying a following relationship:
n2×(R2−R1+d)−d×n1=0;
wherein n1 is the first refractive index, n2 is the second refractive index, R1 is a radius of curvature of the first side surface, R2 is a radius of curvature of the second side surface, and d is a shortest distance between the first side surface and the second side surface.

9. The optical waveguide structure according to claim 1, wherein the second refractive index ranges from 1.3 to 2.5.

10. The optical waveguide structure according to claim 1, wherein the first light-guiding part comprises a transparent solid material, and the second light-guiding part comprises a material selected from the group consisting of a transparent solid and a transparent liquid.

11. The optical waveguide structure according to claim 1, wherein the input grating and the output grating are on a same surface of the first light-guiding part; or the input grating and the output grating are on opposite surfaces of the first light-guiding part, respectively.

12. A display device comprising:
a display configured for emitting image light; and
an optical waveguide structure comprising an optical waveguide, an input grating and an output grating;
wherein the optical waveguide comprises a first light-guiding part having a first refractive index and a second light-guiding part spliced with the first light guide portion and having a second refractive index greater than the first refractive index;
the input grating is on the first light-guiding part and configured to couple the image light into the optical waveguide;
the output grating is on the first light-guiding part and configured to couple the image light out of the optical waveguide; and
the second light-guiding part is positioned in an optical path between the input grating and the output grating and configured to expand the image light.

13. The display device according to claim 12, further comprising a collimating lens between the display and the input grating and configured to convert the image light from the display into a parallel light and emit the parallel light to the input grating.

14. The display device according to claim 12, wherein the display device is an augmented reality (AR) near-eye display device or an AR head-up display device.

15. The display device according to claim 12, wherein the first light-guiding part surrounds the second light-guiding part; or wherein the first light-guiding part comprises a first portion and a second portion separated from each other, the input grating is on the first portion, the output grating is on the second portion, and the second light-guiding part is between and interfaces with the first portion and the second portion.

16. The display device according to claim 12, wherein the first light-guiding part and the second light-guiding part each have two opposing surfaces in a thickness direction of the optical waveguide, and the two opposing surfaces of the first light-guiding part are substantially and respectively coplanar with the two opposing surfaces of the second light-guiding part.

17. The display device according to claim 16, wherein the second light-guiding part further comprises a first side surface connected to the first light-guiding part and a second side surface connected to the first light-guiding part, and the first side surface is closer to the input grating than to the second side surface; and the first side surface and the second side surface are substantially planar surfaces parallel to each other.

18. The display device according to claim 16, wherein the second light-guiding part further comprises a first side surface connected to the first light-guiding part and a second side surface connected to the first light-guiding part, and the first side surface is closer to the input grating than to the second side surface; and each of the first side surface and the second side surface is a curved surface having one curvature convex toward the output grating.

19. The display device according to claim 18, wherein each of the first side surface and the second side surface is a spherical curved surface, and the optical waveguide satisfies a following relationships:
R2≥R1; and n2×(R2−R1+d)−d×n1=0;
wherein R1 is a radius of curvature of the first side surface, R2 is a radius of curvature of the second side surface, n1 is the first refractive index, n2 is the second refractive index, and d is a shortest distance between the first side surface and the second side surface.

20. The display device according to claim 12, wherein the second refractive index ranges from 1.3 to 2.5, and the second light-guiding part comprises a material selected from the group consisting of a transparent solid and a transparent liquid.
